(19) United States
(12) Patent Application Publication
(10) Pub. No.: US 2018/0194190 A1
(43) Pub. Date: Jul. 12, 2018

(54) VEHICLE AIR CONDITIONING DEVICE

(71) Applicant: HANON SYSTEMS, Daejeon (KR)

(72) Inventors: Yong Sik KIM, Daejeon (KR); Seok KIM, Daejeon (KR); Seung Sik WON, Daejeon (KR)

(21) Appl. No.: 15/739,813

(22) PCT Filed: Sep. 29, 2016
(86) PCT No.: PCT/KR2016/010885

§ 371 Date: Dec. 26, 2017

(30) Foreign Application Priority Data
Sep. 30, 2015 (KR) 10-2015-0137427
Sep. 26, 2016 (KR) 10-2016-0123349

(51) Int. Cl. B60H 1/00; B60H 1/22; B60H 1/32

(52) U.S. Cl. CPC B60H 1/0005; B60H 1/00685; B60H 1/22; B60H 2001/2281; B60H 2001/00092; B60H 2001/00714; B60H 1/3211

(57) ABSTRACT

The present invention relates to a vehicle air conditioning device capable of improving sealing ability by doubly sealing a defrost vent of an air conditioning case, and increasing the amount of airflow discharged inside a vehicle while simultaneously preventing an increase in the amount of force needed to actuate a face door and, more particularly, to a vehicle air conditioning device comprising: a ball; the air conditioning case in which a floor vent is formed; a defrost door installed to be rotatable via rotation shafts respectively inside the air conditioning case, and opening and closing each of the vents; the face door; the defrost vent for discharging air entering through the floor door and an air inlet inside the air conditioning case; and a face vent (in the passage of which an evaporator and a heater core are installed in that order), wherein the vehicle air conditioning device is characterized in that the face door is configured to doubly seal the defrost vent.

### TECHNICAL FIELD

The present invention relates to an air conditioner for a vehicle, which can improving sealability by doubly shielding a defrost vent of an air conditioning case, and increasing an amount of air discharged to the interior of a vehicle while preventing an increase of an actuating force of mode doors generated by negative pressure of the air.

### BACKGROUND ART

In general, an air conditioner for a vehicle is a car part, which is installed in a vehicle for the purpose of cooling or heating the interior of the vehicle in the summer season or the winter season or removing frost from a windshield in the rainy season or the winter season to thereby secure a driver's front and rear visual fields. Such an air conditioner typically includes a heating device and a cooling device together, so that it can heat, cool or ventilate the interior of the vehicle through the steps of selectively introducing the indoor air or the outdoor air into the air conditioner, heating or cooling the introduced air, and blowing the heated or cooled air into the vehicle.

According to mounted structures of an air blower unit, an evaporator unit and a heater core unit, such an air conditioner is classified into a three-piece type air conditioner where the air blower unit, the evaporator unit, and the heater core unit are disposed independently, a semi-center type air conditioner where the evaporator unit and the heater core unit are embedded in an air-conditioning case and the air blower unit is mounted separately, and a center-mounting type air conditioner where the three units are all embedded in the air-conditioning case.

Recently, a dual zone type air conditioner, which separately and independently provides air of different temperatures to a driver's seat and to a passenger's seat inside the vehicle to thereby individually heat and cool the seats according to the driver's or the passenger's need, has been disclosed.

FIG. 1 is a configurative diagram of a conventional semi-center type air conditioner for a vehicle. The air conditioner includes: an air conditioning case 10 having an air inflow port 11 formed at an inlet and a defrost vent 12a, a face vent 12b and floor vents 12c and 12d mounted at an outlet; a blower (not shown) connected to the air inflow port 11 of the air conditioning case 10 to blow indoor air or outdoor air; an evaporator 2 and a heater core 3 respectively mounted on an air passageway inside the air conditioning case 10; and a temperature adjusting door 15 mounted between the evaporator 2 and the heater core 3 to adjust the degree of opening of a cold air passageway P1, which bypasses the heater core 3, and the degree of opening of a warm air passageway P2, which passes through the heater core 3.

Moreover, the floor vents 12c and 12d are divided into a floor vent 12c for a front seat and a floor vent 12d for a rear seat.

Furthermore, the temperature adjusting door 15 and mode doors 16 may be flat type doors, which respectively include rotary shafts 15b and 16b rotatably mounted at both sides of the air passageway inside the air conditioning case 10, and plates 15a and 16a formed at one side of each of the rotary shafts 15b and 16b. Alternatively, the temperature adjusting door 15 and the mode doors 16 may be center pivot type doors having plates 16a at both sides of the rotary shaft.

The temperature adjusting door 15 and the mode doors 16 are connected to a cam (not shown) or a lever (not shown) driven by an actuator (not shown) mounted on the outer surface of the air conditioning case 10 and are operated rotatably so as to adjust the degree of opening of the cold air passageway P1 and the warm air passageway P2 or adjust the degree of opening of passageways facing the vents 12a to 12d.

According to the conventional air conditioner 1 having the above structure, in the maximum cooling mode, the temperature adjusting door 15 opens the cold air passageway P1 and closes the warm air passageway P2. Therefore, the air blown by a blower (not shown) is changed into cold air by exchanging heat with refrigerant flowing inside the evaporator 2 while passing through the evaporator 2, and then, is flown toward a mixing chamber MC through the cold air passageway P1. After that, the air is discharged to the interior of the vehicle through the vents 12a to 12d opened according to an air discharge mode, such that the interior of the vehicle is cooled.

Furthermore, in the maximum heating mode, the temperature adjusting door 15 closes the cold air passageway P1 and opens the warm air passageway P2. Therefore, the air blown by the blower (not shown) is changed into warm air by exchanging heat with cooling water flowing inside the heater core 3 while passing through the heater core 3 through the warm air passageway P2 after passing the evaporator 2.

After that, the air flows toward the mixing chamber MC, and then, is discharged to the interior of the vehicle through the vents 12a to 12d opened according to the air discharge mode, such that the interior of the vehicle is heated.

In the meantime, in a cooling mode which is not the maximum cooling mode, namely, in a half cooling mode, the temperature-adjusting door 15 is rotated to a neutral position, and opens all of the cold air passageway P1 and the warm air passageway P2 relative to the mixing chamber (MC). Accordingly, the cold air passing through the evaporator 2 and the warm air passing through the heater core 3 flow toward the mixing chamber (MC) and are mixed with each other, and then, are discharged to the inside of the vehicle through the vents 12a to 12d opened according to the air discharge mode.

However, in such a conventional air conditioner 1 for the vehicle, in the case that the mode door 16 is the flat type door or the center pivot type door, because the opening direction of the mode door 16 is opposed to the flow direction of the air passing through the vents 12a to 12d, the flow of the air introduced into the vents 12a to 12d is obstructed.

Additionally, because the obstruction in air flow forms negative pressure on the plate of the mode door 16, it causes an increase of actuating force for actuating the mode door 16.

In addition, the conventional air conditioner for the vehicle has another disadvantage in that a windshield at the front side of the vehicle is covered with frost because an unintended leak of air occurs through a gap between the mode door 16, which opens and closes the defrost vent 12, and the defrost vent 12, and it causes inconvenience in use.

### DISCLOSURE

### Technical Problem

Accordingly, the present invention has been made in an effort to solve the above-mentioned problems occurring in the prior arts, and it is an object of the present invention to provide an air conditioner for a vehicle, in which a face door of a rotary type rotates toward an inlet of a defrost vent to shield and doubly seal the defrost vent in an air conditioning mode to open a face vent one hundred percent, thereby preventing frosting of a windshield caused by a leak of the defrost vent. Another object of the present invention is to provide an air conditioner for a vehicle, in which a shielding plate of the face door is actuated in a perpendicular direction to an air flow direction inside an air conditioning case and there is no rotary shaft at the middle part of the face door, thereby preventing obstruction of air flow and preventing an increase of a door actuating force.

### Technical Solution

To achieve the above objects, the present invention provides an air conditioner for a vehicle including: an air conditioning case having a defrost vent, a face vent and a floor vent for discharging air introduced through an air inflow port; a defrost door, a face door and a floor door, which are rotatably mounted inside the air conditioning case through rotary shafts to respectively open and close the defrost vent, the face vent and the floor vent; and a heat exchanger for cooling and a heat exchanger for heating, which are mounted on an air passageway formed inside the air conditioning case, wherein two or more doors of the plural doors shield one of the plural vents at the same time.

In another aspect of the present invention, the present invention provides an air conditioner for a vehicle including: an air conditioning case having a plurality of vents for discharging air introduced through an air inflow port; a plurality of doors, which are rotatably mounted inside the air conditioning case through rotary shafts to respectively open and close the vents; and a heat exchanger for cooling and a heat exchanger for heating, which are mounted on an air passageway formed inside the air conditioning case, wherein one of the plural doors selectively shields two or more vents of the plural vents.

### Advantageous Effects

The air conditioner for a vehicle according to an embodiment of the present invention has the face door of the rotary type, which is formed to shield the inlet of the defrost vent by rotation, such that the face door can form a double sealing structure together with the defrost door, thereby preventing frosting of the windshield caused by an air leak of the defrost vent in the vent mode.

Furthermore, the air conditioner for a vehicle according to an embodiment of the present invention can prevent an increase of the actuating force of the doors while increasing an amount of the air discharged to the interior of the vehicle because there is no structure like the rotary shaft, which obstructs the flow of air, at the middle part of the face door of the rotary type and the shielding plate of the face door rotates in the perpendicular direction to the air flow direction.

### DESCRIPTION OF DRAWINGS

FIG. 1 is a side sectional view of a conventional air conditioner for a vehicle.

FIG. 2 is a side sectional view of an air conditioner for a vehicle according to a preferred embodiment of the present invention.

FIG. 3 is an exploded perspective view of the air conditioner for a vehicle according to the preferred embodiment of the present invention.

FIG. 4 is a perspective view showing an upper part of the air conditioner for a vehicle according to the preferred embodiment of the present invention.

FIG. 5 is a perspective view showing a face door of the air conditioner for a vehicle according to the preferred embodiment of the present invention.

FIG. 6 is a front view of the face door illustrated in FIG. 5.

FIGS. 7 to 11 are side sectional views showing operational states by air discharge modes of the air conditioner for a vehicle according to the preferred embodiment of the present invention.

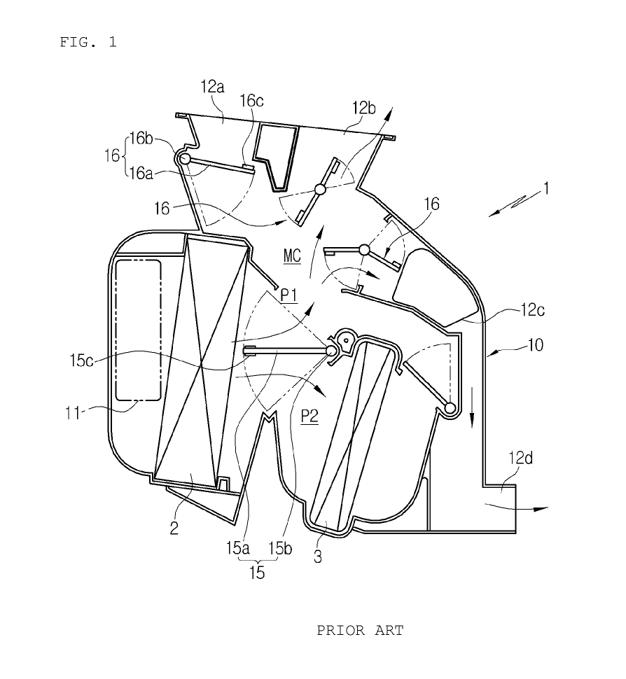

### MODE FOR INVENTION

Hereinafter, reference will be now made in detail to exemplary embodiments of the present invention with reference to the attached drawings.

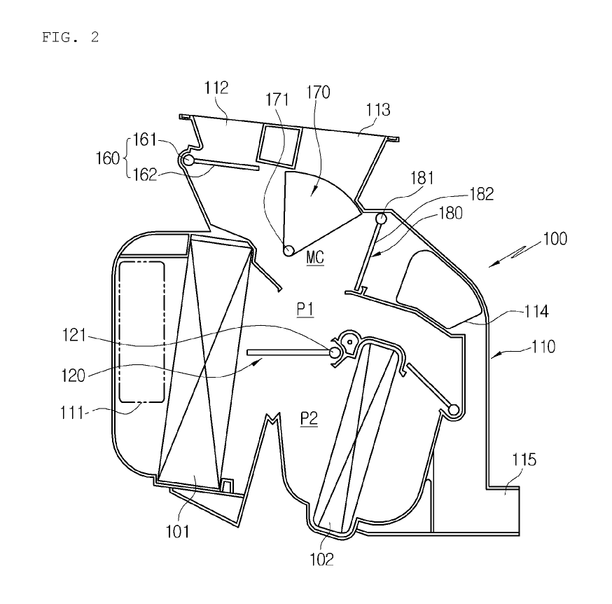

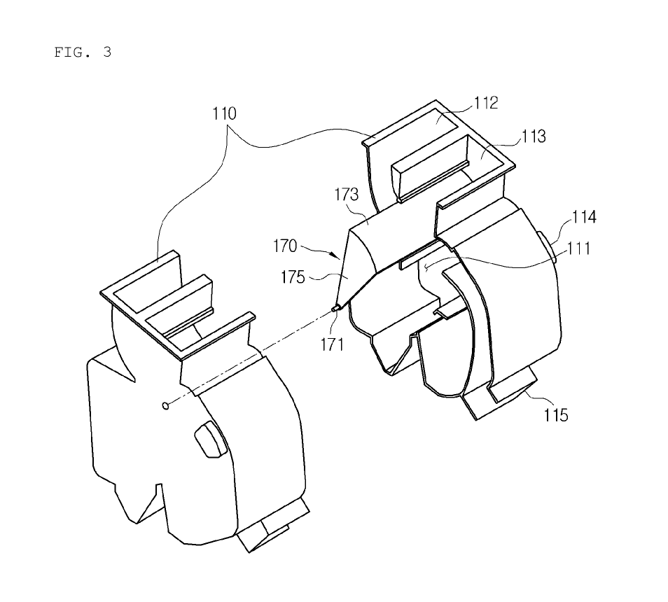

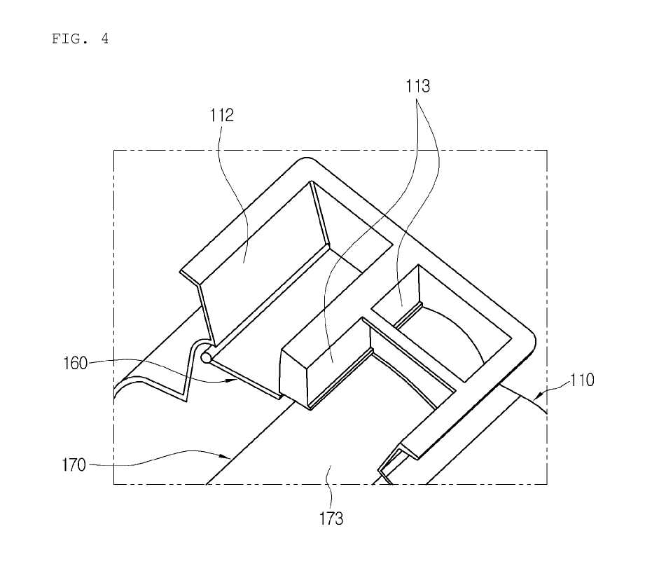

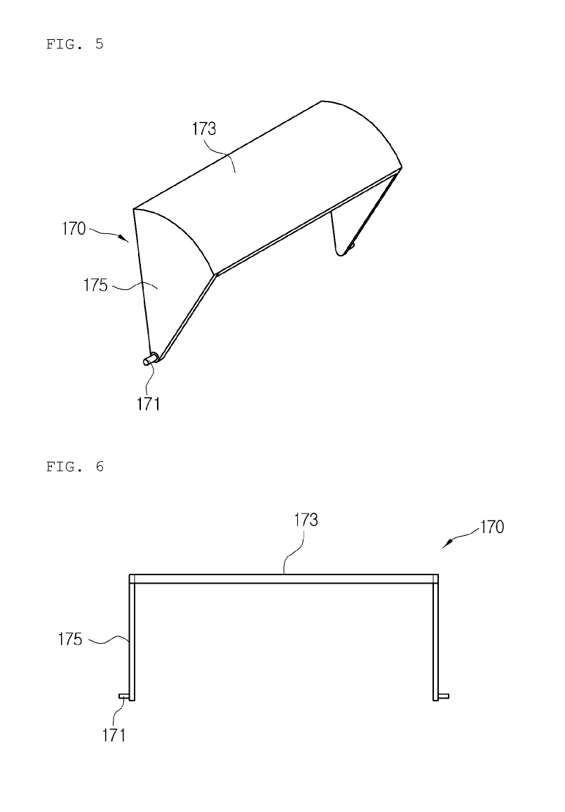

FIG. 2 is a side sectional view of an air conditioner for a vehicle according to a preferred embodiment of the present invention, FIG. 3 is an exploded perspective view of the air conditioner for a vehicle according to the preferred embodiment of the present invention, FIG. 4 is a perspective view showing an upper part of the air conditioner for a vehicle according to the preferred embodiment of the present invention, FIG. 5 is a perspective view showing a face door of the air conditioner for a vehicle according to the preferred embodiment of the present invention, and FIG. 6 is a front view of the face door illustrated in FIG. 5.

As illustrated in the drawings, the air conditioner 100 for a vehicle according to the preferred embodiment of the present invention includes an air conditioning case 110, and the air conditioning case 110 has an air inflow port 111 formed at an inlet and an air passageway formed therein.

Moreover, a blower (not shown) for blowing indoor air or outdoor air is mounted at the air inflow port 111 of the air conditioning case 110.

A heat exchanger for cooling is mounted inside the air passageway in order to cool air flowing along the air passageway. Furthermore, the air passageway branches off to a cold air passageway P1 and a warm air passageway P2. A heat exchanger for heating is mounted on the warm air passageway P2, and a temperature adjusting door 120 is mounted at a branched point between the cold air passageway P1 and the warm air passageway P2.

In the meantime, preferably, the heat exchanger for cooling is an evaporator 101, and the heat exchanger for heating is a heater core 102.

Cold air cooled by the evaporator 101 passes through the cold air passageway P1, and warm air heated by the heater core 102 passes through the warm air passageway P2.

The temperature adjusting door 120 adjusts the degree of opening of the cold air passageway P1 and the warm air passageway P2 while rotating between the cold air passageway P1 and the warm air passageway P2 in order to adjust temperature of cold air and warm air supplied to the interior of the vehicle.

An outlet of the warm air passageway P2 merges into one with the cold air passageway P1. Moreover, the warm air passageway P2 merged with the cold air passageway P1 forms a mixing chamber MC. The mixing chamber MC mixes the warm air flowing along the warm air passageway P2 and the cold air flowing along the cold air passageway P1 together.

Therefore, the mixed warm air and cold air is supplied to the interior of the vehicle through a plurality of air outflow ports while keeping proper temperature.

The air outflow ports are a defrost vent 112 for discharge air toward a windshield of the vehicle, a face vent 113 for discharge air toward the face of a passenger, who is sitting on the front seat, and a floor vent 114 for discharging air toward the passenger's feet. Here, the floor vent 114 discharges air toward the feet of the passenger, who is sitting on the front seat. Of course, another floor vent 115 for a rear seat may be formed to discharge air toward the feet of a passenger, who is sitting on the rear seat.

Meanwhile, a plurality of mode doors are respectively mounted at inlets of the vents 112, 113 and 114 to adjust the degree of opening of each vent.

The mode doors are a defrost door 160 for opening and closing the defrost vent 112, a face door 170 for opening and closing the face vent 113, and a floor door 180 for opening and closing the floor vent 114.

The temperature adjusting door 120 and the mode doors respectively include rotary shafts 121, 161, 171 and 181 rotatably combined to the inner wall surface of the air conditioning case 110, and respectively adjust the degrees of opening of the cold air passageway, the warm air passageway and the vents 112, 113 and 114 while the rotary shafts 121, 161, 171 and 181 are rotatably operated by a cam or a lever actuated by an actuator (not shown) mounted on the outer surface of the air conditioning case 110.

According to the preferred embodiment of the present invention, two or more of the plural doors can shield one of the vents 112, 113 and 114 at the same time.

In other words, two or more of the defrost door 160, the face door 170 and the floor door 180 can shield one of the defrost vent 112, the face vent 113 and the floor vent 114 at the same time.

The face door 170 of the plural doors is a rotary type door having a shielding plate 173 for shielding the inlet of the face vent 113.

Of course, the shielding plate 173 of the face door 170 may selectively shield the face vent 113 and the defrost vent 112.

Here, the doors, which shield one of the plural vents 112, 113 and 114, are the defrost door 160 and the face door 170, and the shielded vent is defrost vent 112.

The shielding plate 173 has the size which is capable of covering and shielding the entire area of the face vent 113, is formed in an arc shape in the back-and-forth direction of the face vent 113, and extends as long as the face vent 113 so as to cover the entire lateral length direction of the face vent 113.

Therefore, the shielding plate 173 rotates toward the inlet of the face vent 113 to shield the face vent 113 when the face door 170 rotates toward the face vent 113 by the rotary shaft 171, and rotates toward the inlet of the defrost vent 112 to shield the defrost vent 112 when rotating toward the defrost vent 112 in reverse.

Furthermore, the defrost door 160 and the floor door 180 except the face door 170 are flat type doors respectively having plates 162 and 182 extending to one side of the rotary shafts 161 and 181.

In this instance, the defrost door 160 is located more downstream in an air flow direction than the inlet of the defrost vent 112, at which the shielding plate 173 of the face door 170 is located.

In other words, the rotary shaft 161 of the defrost door 160 is located more downstream in the air flow direction than the inlet of the defrost vent 112.

Therefore, the shielding plate 173 of the face door 170 shields the inlet of the defrost vent 112, and at the same time, the defrost door 160 shields the downstream side of the shielding plate 173, such that a double shielding structure is formed.

As described above, like a vent mode of the air conditioner, in a mode to open the face vent 113 a hundred percent, the shielding plate 173 of the face door 170 rotates toward the defrost vent 112 to perfectly shield the inlet of the defrost vent 112 and the defrost door 160 shields the defrost vent 112 at the downstream side of the shielding plate 173 to doubly seal the defrost vent 112, thereby improving sealability by preventing air leak and preventing frosting of the windshield by a leak through the defrost vent 112.

In the meantime, the face door 170 includes a pair of side support plates 175, which are formed at both sides of the shielding plate 173, and rotary shafts 171, which are respectively formed at the side support plates 175 and joined to both sides of the air conditioning case 110 inside the air conditioning case 110.

That is, the face door 170 is joined to both sides of the air conditioning case 110, which are located lower than the shielding plate 173, via the rotary shafts 171, and includes a pair of side support plates 175, which connect both right and left end portions of the shielding plate 173 with the rotary shafts 171.

In this instance, the shielding plate 173 of the face door 170 is arranged more downstream in the air flow direction than the rotary shafts 171.

The face door 170 is formed in the shape of ‘ [symbol] ’ which is opened at the lower part when it is viewed in the back-and-forth direction of the air conditioning case 110, and there is no structure like the rotary shaft, which obstructs the flow of air, at the lower middle part of the face door 170, such that air fluidity is improved inside the air conditioning case 110.

That is, the rotary shafts 171 are not formed inside the side support plates 175 but formed outside the side support plates 175.

Additionally, the face door 170, which is capable of selectively opening and closing the defrost vent 112 and the face vent 113, is formed in such a way that the shielding plate 173 forms a rotational trajectory in a perpendicular direction to the flow direction of air, which is introduced into the defrost vent 112 and the face vent 113, by the rotary shafts 171.

Therefore, it can prevent negative pressure by the air flow from acting to the shielding plate 173 and also prevent an increase of a door actuating force by formation of the negative pressure.

In addition, the defrost door 160 mounted at the downstream side of the defrost vent 112 may be formed in a flat type.

In this instance, the defrost door 160 includes a rotary shaft 161 located at one side of the defrost vent 112 and a plate 162 extending to one side from the rotary shaft 161 to open and close the defrost vent 112.

As described above, the flat type defrost door 160 is formed to operate in link with the face door when being actuated by the cam or the lever actuated by the actuator to open and close the defrost vent 112.

As an example, the defrost door 160 rotates in the opposite direction to the face door 170 to doubly shield the defrost vent 112 when the shielding plate 173 of the face door 170 rotates from the inlet of the face vent 113 to the inlet of the defrost vent 112.

Moreover, in the mode to shield both of the defrost vent 112 and the face vent 113, while the face door 170 keeps the state where it shields the face vent 113, only the defrost door 160 is independently operated to shield the defrost vent 112.

In another embodiment of the present invention, one of the plural doors may selectively shield two or more vents of the plural vents.

In other words, one of the defrost door 160, the face door 170 and the floor door 180 may selectively shield two or more vents of the defrost vent 112, the face vent 113 and the floor vent 114.

One of the two or more vents is the defrost vent 112. Here, the two or more vents are the defrost vent 112 and the face vent 113.

The door, which selectively shields the two or more vents, is a rotary door.

In this instance, the air conditioning case 110 has three seating parts (not shown) for the door, which selectively shields the two or more vents, namely, the rotary door.

That is, ‘ [symbol] ’-shaped three sides formed at one side of the rotary door are seated on three seating parts formed at the inner face of one side of the air conditioning case 110 when the rotary door shields the face vent 113, and ‘ [symbol] ’-shaped three sides formed at the other side of the rotary door are seated on three seating parts formed at the inner face of the other side of the air conditioning case 110 when the rotary door shields the defrost vent 112.

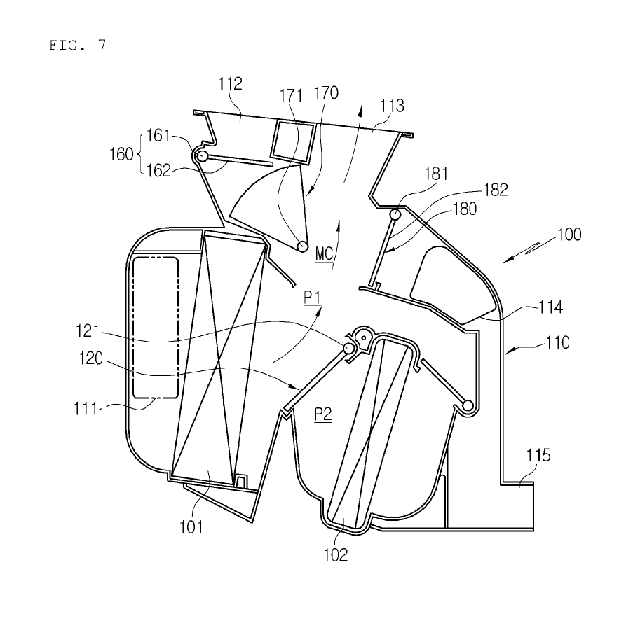

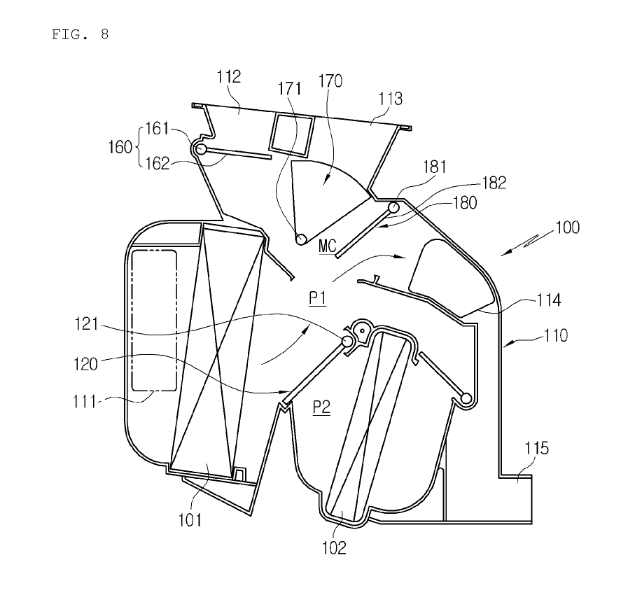

FIGS. 7 to 11 are side sectional views showing operational states by air discharge modes of the air conditioner for a vehicle according to the preferred embodiment of the present invention.

Hereinafter, referring to FIGS. 7 to 11, the air discharge modes of the air conditioner 100 for the vehicle according to the embodiment of the present invention will be described, and for convenience sake, the air discharge modes will be described on the basis of the cooling mode.

A. Vent Mode

As shown in FIG. 7, in the vent mode, the face door 170 rotates toward the defrost vent 112 to open the face vent 113, the defrost door 160 closes the defrost vent 112, and the floor door 180 closes the floor vents 114 and 115.

Moreover, the face door 170 doubly seals the defrost vent 112 together with the defrost door 160, such that the shielding plate 173 rotates toward the inlet of the defrost vent 112 to shield the defrost vent 112.

Therefore, the air blown by the blower is changed into cold air while passing through the evaporator 101.

After that, the cold air cooled while passing through the evaporator 101 bypasses the heater core 102 by the temperature adjusting door 120, and then, is discharged toward the passenger's face through the face vent 113.

B. Floor Mode

As shown in FIG. 8, in the floor mode, the floor door 180 opens the floor vents 114 and 115, and the defrost door 160 and the face door 170 respectively close the defrost vent 112 and the face vent 113.

Of course, in the floor mode, the defrost door 160 may partially open the defrost vent 112.

In this instance, the face door 170 is located to shield the face vent 113.

Therefore, the air blown by the blower is changed into cold air while passing through the evaporator 101.

After that, the cold air cooled while passing through the evaporator 101 bypasses the heater core 102 by the temperature adjusting door 120, and then, is discharged toward the passenger's feet through the floor vent 114.

C. Defrost Mode

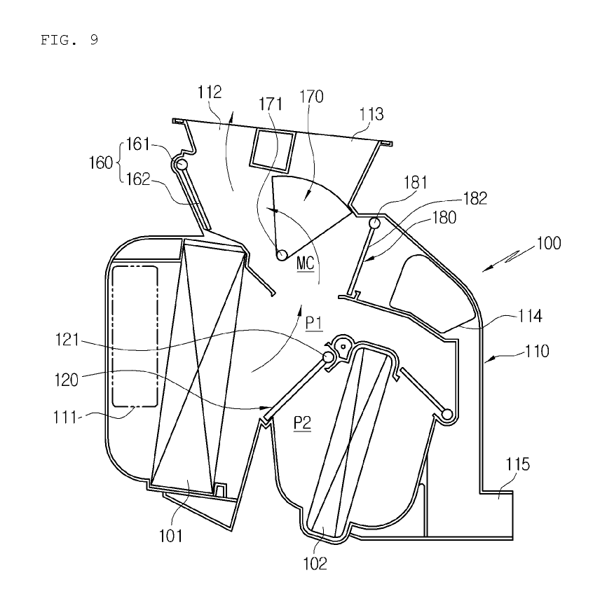

As shown in FIG. 9, in the defrost mode, the defrost door 160 opens the defrost vent 112.

The face door 170 is located to make the shielding plate 173 close the face vent 113 so as to open the defrost vent 112, and the floor door 180 closes the floor vents 114 and 115.

Therefore, the air blown by the blower is changed into cold air while passing through the evaporator 101.

After that, the cold air cooled while passing through the evaporator 101 bypasses the heater core 102 by the temperature adjusting door 120, and then, is discharged toward the window inside the vehicle through the defrost vent 112.

D. Bi-Level Mode and Mixing Mode

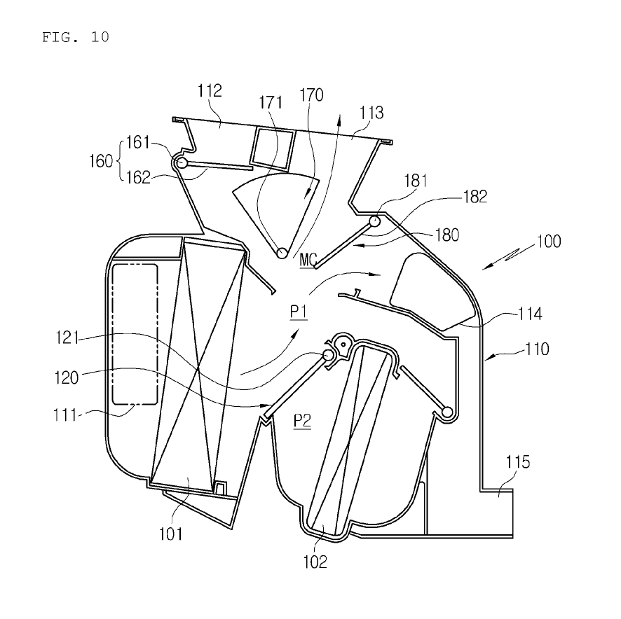

As shown in FIG. 10, in the bi-level mode to open the face vent 113 and the floor vents 114 and 115 at the same time, the face door 170 partially opens the face vent 113 when the shielding plate 173 rotates toward the defrost vent 112 at a predetermined angle, and the floor door 180 partially opens the floor vent 114.

In this instance, the defrost door 160 closes the defrost vent 112.

Therefore, the cold air cooled while passing through evaporator 101 is discharged toward the passenger's face and feet at the same time.

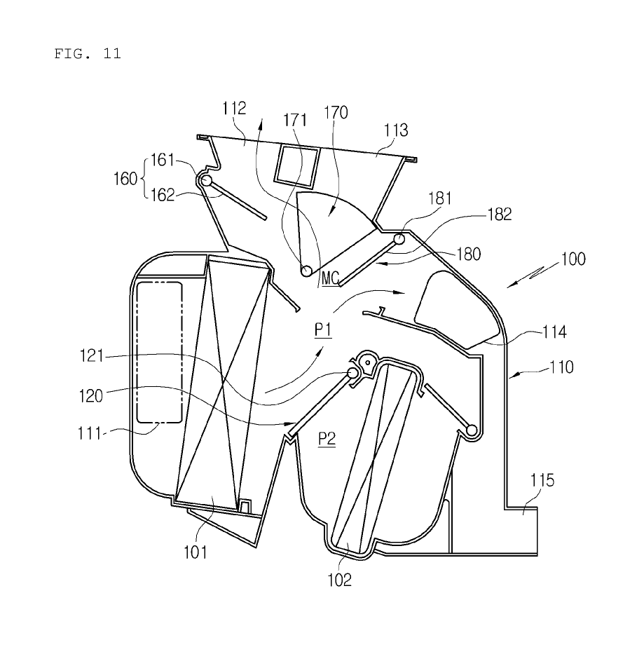

In the meantime, as shown in FIG. 11, in the mixing mode, the face door 170 shields the face vent 113, and the defrost door 160 and the floor door 180 partially open the defrost vent 112 and the floor vent 114.

In the mixing mode, wind distribution of the cold air discharged to the defrost vent 112 and the floor vent 114 may be adjusted when the defrost door 160 and the floor door 180 are controlled individually.

As described above, while the present invention has been particularly shown and described with reference to the example embodiments thereof, it will be understood by those of ordinary skill in the art that the above embodiments of the present invention are all exemplified and various changes, modifications and equivalents may be made therein without changing the characteristics and scope of the present invention. Therefore, it would be understood that the protective scope of the present invention shall be defined by the technical ideas of the following claims.

1. An air conditioner for a vehicle, which includes: an air conditioning case having a defrost vent, a face vent and a floor vent for discharging air introduced through an air inflow port; a defrost door, a face door and a floor door, which are rotatably mounted inside the air conditioning case through rotary shafts to respectively open and close the defrost vent, the face vent and the floor vent; and a heat exchanger for cooling and a heat exchanger for heating, which are mounted on an air passageway formed inside the air conditioning case,
wherein two or more doors of the plural doors shield one of the plural vents at the same time.

2. The air conditioner according to claim 1, wherein the face door is a rotary type door having a shielding plate for selectively shielding the face vent and the defrost vent.

3. The air conditioner according to claim 1, wherein the defrost door is a flat type door having a plate extending from the rotary shaft to one side.

4. The air conditioner according to claim 1, wherein the rotary shaft of the defrost door is located more downstream in an air flow direction than an inlet of the defrost vent.

5. The air conditioner according to claim 1, wherein the defrost door rotates in the opposite direction to the face door to shield the defrost vent at the same time when the face door rotates toward the inlet of the defrost vent.

6. The air conditioner according to claim 2, wherein the face door comprises a pair of side support plates formed at both sides of the shielding plate and rotary shafts respectively formed at the side support plates, such that the face door is combined to the air conditioning case.

7. The air conditioner according to claim 2, wherein in a mode to open the face vent a hundred percent, the face door perfectly shields the defrost vent when the shielding plate rotates toward the defrost vent.

8. The air conditioner according to claim 2, wherein the face door is formed in such a way that the shielding plate forms a rotational trajectory in a perpendicular direction to the flow direction of the air, which is introduced into the defrost vent and the face vent.

9. The air conditioner according to claim 6, wherein the shielding plate of the face door is arranged more downstream in the air flow direction than the rotary shaft.

10. The air conditioner according to claim 1, wherein the doors for shielding one of the plural vents are the defrost door and the face door.

11. The air conditioner according to claim 10, wherein the one of the plural vents is the defrost vent.

12. An air conditioner for a vehicle, which includes: an air conditioning case having a plurality of vents for discharging air introduced through an air inflow port; a plurality of doors, which are rotatably mounted inside the air conditioning case through rotary shafts to respectively open and close the vents; and a heat exchanger for cooling and a heat exchanger for heating, which are mounted on an air passageway formed inside the air conditioning case,
wherein one of the plural doors selectively shields two or more vents of the plural vents.

13. The air conditioner according to claim 12, wherein one of the two or more vents is a defrost vent.

14. The air conditioner according to claim 12, wherein the door, which selectively shields the two or more vents, is a rotary door.

15. The air conditioner according to claim 12, wherein the air conditioning case has three seating parts for the door, which selectively shields the two or more vents.
